(19) United States
(12) Patent Application Publication
(10) Pub. No.: US 2026/0159171 A1
(43) Pub. Date: Jun. 11, 2026

(54) VEHICLE FRONT STRUCTURE

(71) Applicants: Hyundai Motor Company, Seoul (KR); Kia Corporation, Seoul (KR)

(72) Inventors: Hyun Wook PARK, Hwaseong-Si (KR); Kun Ho PARK, Hwaseong-Si (KR)

(73) Assignees: Hyundai Motor Company, Seoul (KR); Kia Corporation, Seoul (KR)

(21) Appl. No.: 19/179,735

(22) Filed: Apr. 15, 2025

(30) Foreign Application Priority Data
Oct. 31, 2024 (KR) 10-2024-0152950

(51) Int. Cl. B62D 21/15

(52) U.S. Cl. CPC B62D 21/155

(57) ABSTRACT

A vehicle front structure, includes a front end module including a crossmember and a pair of side members extending vertically from first and second end portions of the crossmember; a pair of vertical members connected on a rear surface of the front end module; a pair of fender apron members connected to top end portions of the pair of vertical members, respectively; and a pair of front side members connected to a middle portion of the front end module, wherein each fender apron member extends in a longitudinal direction of a vehicle.

### CROSS-REFERENCE TO RELATED APPLICATION

The present application claims priority to Korean Patent Application No. 10-2024-0152950, filed on Oct. 31, 2024, the entire contents of which is incorporated herein for all purposes by this reference.

### BACKGROUND OF THE PRESENT DISCLOSURE

### Field of the Present Disclosure

The present disclosure relates to a vehicle front structure, and more particularly, to a vehicle front structure designed to distribute a load in the event of a vehicle collision/impact.

### Description of Related Art

A vehicle may include a front compartment and a passenger compartment partitioned by a dash panel. A powertrain including a prime mover may be disposed in the front compartment. For example, an internal combustion engine vehicle may have a powertrain including an internal combustion engine in the front compartment, and an electric vehicle may have a powertrain including an electric motor in the front compartment.

The front compartment may be defined by a vehicle front structure, and the vehicle front structure may include a front end module, a pair of front side members connected to the front end module, a pair of fender apron members connected to the front end module, a pair of damper housings connected to the pair of front side members, and a dash panel.

The pair of front side members may be spaced apart from each other in a width direction of the vehicle. Each fender apron member may be bent in up/down and left/right directions, and a front end portion of the fender apron member may be connected to a front bumper. The pair of fender apron members may support fenders located on left and right sides of the vehicle. Each damper housing may support a damper such as a shock absorber of a vehicle suspension system. Each damper housing may be disposed between the corresponding front side member and the corresponding fender apron member. A cowl may be attached to a top end portion of the dash panel.

In a vehicle front structure according to the related art, an upper crossmember of the front end module may be formed of a plastic molding or a plastic molding with a steel insert so that stiffness thereof may be relatively poor, and accordingly the upper crossmember may be difficult to transfer a load.

Furthermore, the fender apron member in the related art vehicle front structure may be bent in up/down and left/right directions to have a 3D bending shape, making it difficult to support the load and easy to bend. Accordingly, the fender apron member may fail to stably support the load in the event of a vehicle collision/impact such as a frontal collision, a small-overlap crash, and an offset collision.

Thus, the related art vehicle front structure may fail to uniformly distribute the load in the event of a vehicle collision/impact.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle front structure designed to include a fender apron member connected to a top end portion of a vertical member connected on a front end module, allowing the fender apron member to stably support a load, and uniformly distribute the load in the event of a vehicle collision/impact.

According to an aspect of the present disclosure, a vehicle front structure may include: a front end module including a crossmember and a pair of side members extending vertically from first and second end portions of the crossmember; a pair of vertical members connected on a rear surface of the front end module; a pair of fender apron members connected to top end portions of the pair of vertical members, respectively; and a pair of front side members connected to a middle portion of the front end module. Each fender apron member may extend in a longitudinal direction of a vehicle.

A front end portion of each fender apron member may be at least partially overlapped with and be fixed to a top end portion of the corresponding vertical member.

The vehicle front structure may further include a pair of reinforcing plates fixed to rear surfaces of the pair of side members. The pair of vertical members may be fixed to the pair of reinforcing plates.

A front end portion of each front side member may be fixed to the corresponding reinforcing plate.

The vehicle front structure may further include: a pair of mounting brackets connected to bottom end portions of the pair of vertical members, respectively; and a front sub-frame connected on the pair of mounting brackets.

Each mounting bracket may extend vertically from a bottom end portion of the corresponding vertical member.

The vehicle front structure may further include a front bumper connected to the pair of side members. The front bumper may be connected to the pair of side members through a pair of crash boxes.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a perspective view of a vehicle front structure according to an exemplary embodiment of the present disclosure;

FIG. 2 illustrates an exploded perspective view of a vehicle front structure according to an exemplary embodiment of the present disclosure;

FIG. 3 illustrates a side view of a vehicle front structure according to an exemplary embodiment of the present disclosure;

FIG. 4 illustrates a perspective view of a state in which a crossmember and a side member of a front end module are connected in a vehicle front structure according to an exemplary embodiment of the present disclosure;

FIG. 5 illustrates a view which is viewed from a direction indicated by arrow A of FIG. 3;

FIG. 6 illustrates a view which is viewed from a direction indicated by arrow B of FIG. 3; and

FIG. 7 illustrates a view which is viewed from a direction indicated by arrow C of FIG. 3.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the drawings, the same reference numerals will be used throughout to designate the same or equivalent elements. Furthermore, a detailed description of well-known techniques associated with the present disclosure will be ruled out in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

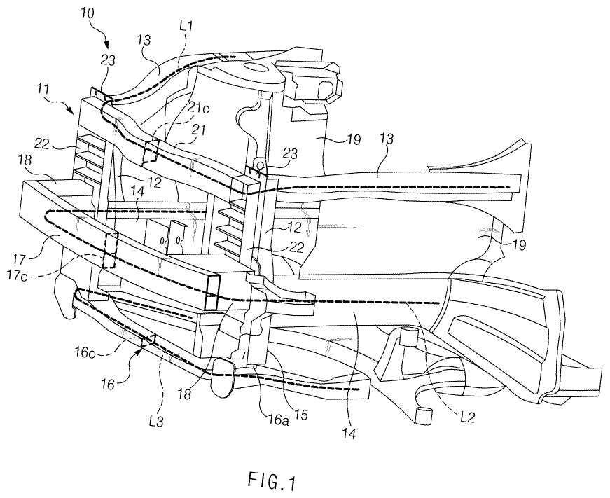

Referring to FIG. 1, a vehicle front structure 10 according to an exemplary embodiment of the present disclosure may include a front end module 11, a pair of vertical members 12 connected on the front end module 11, a pair of fender apron members 13 connected to top end portions of the pair of vertical members 12, and a pair of front side members 14 connected to a middle portion of the front end module 11.

A grille may be disposed in front of the vehicle, and the front end module 11 may be disposed behind the grille. The front end module 11 may include a crossmember 21, and a pair of side members 22 extending vertically from both end portions of the crossmember 21. The crossmember 21 may extend in a width direction of the vehicle, and the crossmember 21 may be made of a material having relatively high stiffness such as steel. The pair of side members 22 may be spaced apart from each other in the width direction of the vehicle, and each side member 22 may extend in a height direction of the vehicle and be made of a plastic material. A reinforcement member made of steel may be inserted into a middle portion of each side member 22. The crossmember 21 and the pair of side members 22 may define an opening in which a heat-exchanger (a radiator, a condenser, and the like) is received.

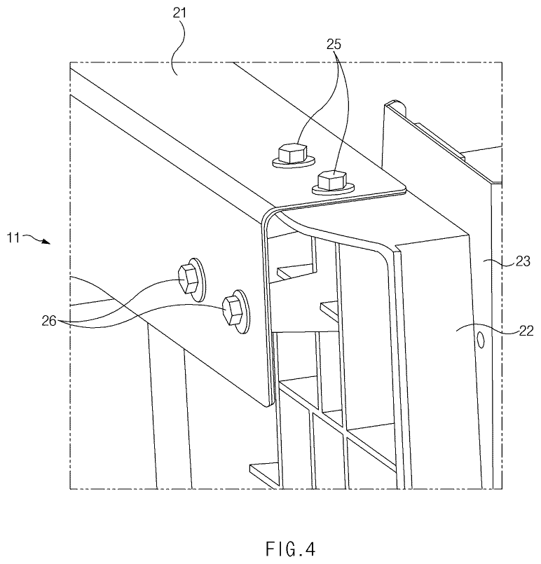

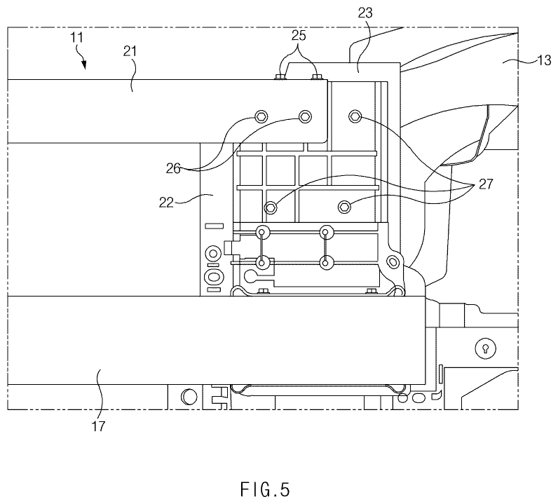

Referring to FIG. 4 and FIG. 5, each end portion of the crossmember 21 may be fixed to a top portion of the corresponding side member 22 through a plurality of fasteners 25 and 26. The plurality of fasteners 25 and 26 may include a plurality of vertical fasteners 25 fixing a top wall of the crossmember 21 and a top surface of the side member 22, and a plurality of horizontal fasteners 26 fixing a front wall of the crossmember 21 and a front surface of the side member 22.

A front bumper 17 may be connected to the middle portion of the front end module 11 through a pair of crash boxes 18. The front bumper 17 may extend in the width direction of the vehicle, and the pair of crash boxes 18 may be fixed to the front bumper 17. The pair of crash boxes 18 may be connected to the pair of side members 22, respectively. A front end portion of each crash box 18 may be fixed to the front bumper 17, and a rear end portion of each crash box 18 may be fixed to the middle portion of the corresponding side member 22.

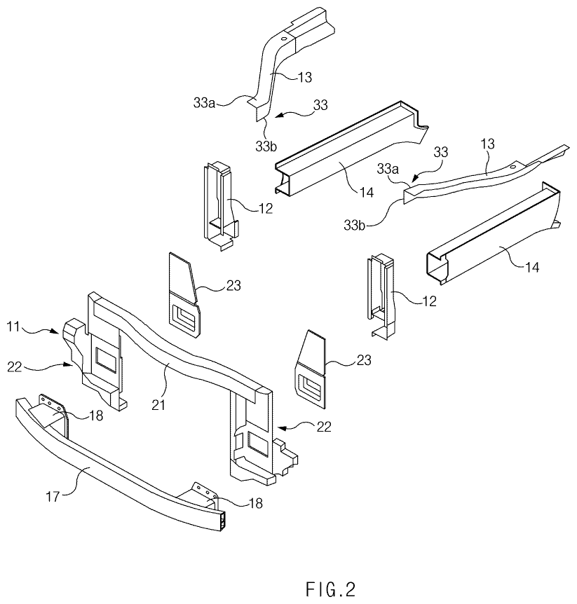

Referring to FIG. 1 and FIG. 2, the pair of vertical members 12 may be spaced apart from each other in the width direction of the vehicle, and the pair of vertical members 12 may be connected on a rear surface of the front end module 11. The pair of vertical members 12 may be connected on rear surfaces of the pair of side members 22, respectively. Each vertical member 12 may extend in the height direction of the vehicle, the top end portion of each vertical member 12 may be adjacent to the top end portion of the corresponding side member 22, and a bottom end portion of each vertical member 12 may be located below or be adjacent to the front bumper 17 and the crash box 18.

Referring to FIG. 1 and FIG. 2, a pair of reinforcing plates 23 may be attached to the rear surfaces of the pair of side members 22, respectively, and the pair of vertical members 12 may be attached to rear surfaces of the pair of reinforcing plates 23, respectively, and accordingly the pair of vertical members 12 may be connected to the pair of side members 22 through the pair of reinforcing plates 23, respectively. Each reinforcing plate 23 may extend in the height direction of the vehicle, and a front surface of the reinforcing plate 23 may be fixed to the rear surface of the corresponding side member 22 so that stiffness of the side member 22 may be improved, and mounting stiffness of the vertical member 12 may be improved. Referring to FIG. 5, the rear surface of each side member 22 may be fixed to the front surface of the corresponding reinforcing plate 23 through a plurality of fasteners 27.

The pair of fender apron members 13 may be spaced apart from each other in the width direction of the vehicle, and each fender apron member 13 may extend in a longitudinal direction of the vehicle.

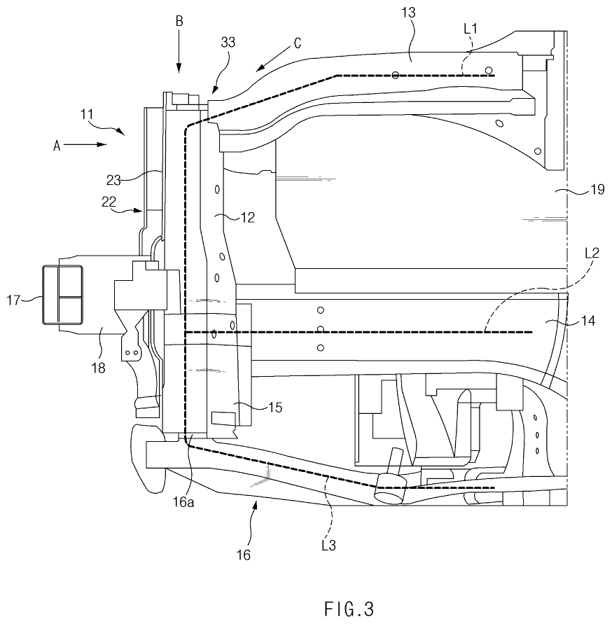

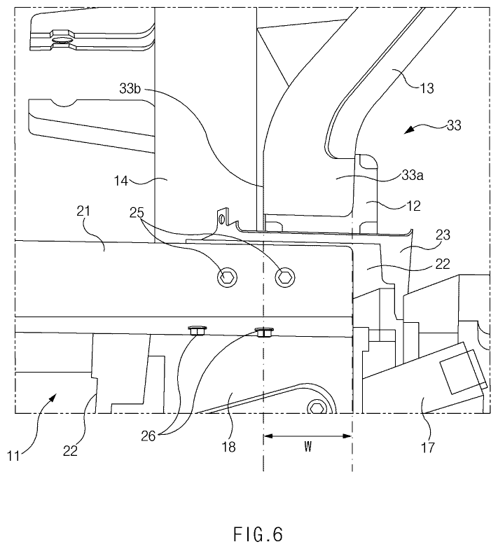

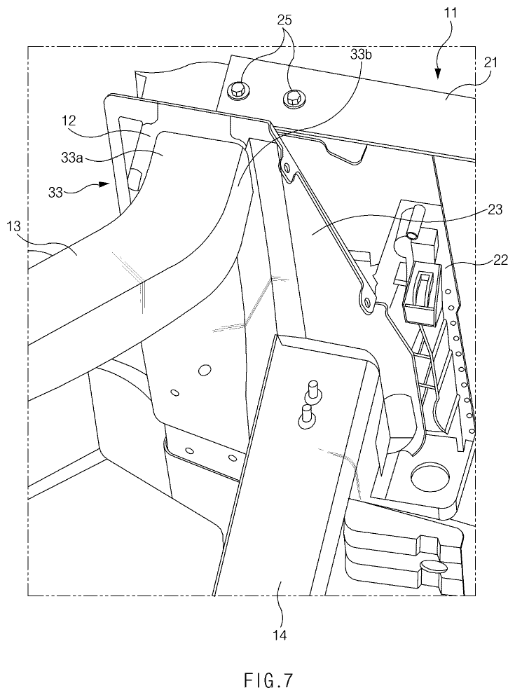

Referring to FIG. 3, a front end portion 33 of each fender apron member 13 may be fixed to the top end portion of the corresponding vertical member 12. Referring to FIG. 6 and FIG. 7, the front end portion 33 of each fender apron member 13 may include a top wall 33a fixed to a top surface of the vertical member 12, and a side wall 33b fixed to a side surface of the vertical member 12 adjacent to the top surface thereof. The top portion wall 33a and the side wall 33b may be perpendicular to each other, and the top portion wall 33a and the side wall 33b may be fixed to the top end portion of the vertical member 12 so that the front end portion 33 of the fender apron member 13 may be securely fixed to the top end portion of the vertical member 12. The front end portion of the fender apron member 13 may be at least partially overlapped with and be fixed to the top end portion of the vertical member 12. Referring to FIG. 6, the top portion wall 33a of each fender apron member and the top surface of the vertical member 12 may be overlapped in a predetermined overlap section W and be fixed to each other.

Referring to FIG. 1, the front end portion 33 of each fender apron member 13 may be fixed to the top end portion of the vertical member 12 so that the front end portions of the pair of fender apron members 13 may be connected to an upper portion of the front end module 11 through the vertical members 12, and accordingly the crossmember 21 of the front end module 11 and the pair of fender apron members 13 may define a ‘U’-shaped upper load path L1 connected to the upper portion of the front end module 11. Since each fender apron member 13 is not bent to the bottom portion of the vehicle and extends in the longitudinal direction of the vehicle, stiffness of the fender apron member 13 may be improved.

The pair of front side members 14 may be connected to the pair of side members 22, respectively. Each front side member 14 may be connected to the middle portion of the corresponding side member 22. Referring to FIG. 7, a front end portion of each front side member 14 may be fixed to the rear surface of the corresponding reinforcing plate 23, and accordingly the front side member 14 may be securely connected on the middle portion of the corresponding side member 22 of the front end module 11 through the reinforcing plate 23.

Referring to FIG. 1, a pair of damper housings 19 may be connected to the pair of fender apron members 13, respectively. A top edge portion of each damper housing 19 may be fixed to the corresponding fender apron member 13 using fasteners, welding, and/or the like, and a bottom edge portion of each damper housing 19 may be fixed to the corresponding front side member 14 using fasteners, welding, and/or the like.

Each front side member 14 may be aligned with the corresponding crash box 18 in the longitudinal direction of the vehicle, and the pair of front side members 14 may be connected to the middle portion of the front end module 11 so that the front bumper 17 and the pair of front side members 14 may define a ‘U’-shaped middle load path L2 connected to the middle portion of the front end module 11.

Referring to FIGS. 1 and 3, a pair of mounting brackets 15 may be connected to the pair of vertical members 12. Each mounting bracket 15 may extend vertically from the bottom end portion of the corresponding vertical member 12 toward the bottom portion of the vehicle.

A top end portion of each mounting bracket 15 may be fixed to the bottom end portion of the corresponding vertical member 12, and a bottom end portion of each mounting bracket 15 may be adjacent to a bottom end portion of the corresponding side member 22. Furthermore, each mounting bracket 15 may be fixed to the rear surface of the corresponding reinforcing plate 23 using fasteners, welding, and/or the like.

A front sub-frame 16 may be disposed below the front end module 11 and the front side members 14, and the front sub-frame 16 may include a pair of front mounts 16a. The front mounts 16a of the front sub-frame 16 may be connected on the bottom end portions of the mounting brackets 15, respectively.

The front sub-frame 16 may be connected to a lower portion of the front end module 11 through the pair of mounting brackets 15, and accordingly the front sub-frame 16 may define a ‘U’-shaped lower load path L3 connected to the lower portion of the front end module 11.

According to another exemplary embodiment of the present disclosure, each mounting bracket 15 may be integrally connected to the corresponding vertical member 12 so that the mounting bracket 15 and the vertical member 12 may form a unitary one-piece structure.

Referring to FIG. 1, the crossmember 21 of the front end module 11 may include a closed cross section 21c, the front bumper 17 may include a closed cross section 17c, and a front cross section of the front sub-frame 16 may include a closed cross section 16c. Accordingly, the vehicle front structure 10 may include the three closed cross sections 21c, 17c, and 16c so that stiffness thereof may be improved.

As set forth above, according to exemplary embodiments of the present disclosure, the fender apron members 13 may be connected to the top end portions of the vertical members 12 fixed to the front end module 11 so that the fender apron members 13 may stably support a load, and accordingly the load may be distributed in the event of a vehicle collision/impact.

According to exemplary embodiments of the present disclosure, the pair of fender apron members 13 may be connected to the upper portion of the front end module 11 through the pair of vertical members 12, the pair of front side members 14 may be connected to the middle portion of the front end module 11 through the pair of reinforcing plates 23, and the front sub-frame 16 may be connected to the lower portion of the front end module 11 through the pair of mounting brackets 15 so that the vehicle front structure 10 may include the three ‘U’-shaped load paths L1, L2, and L3. Accordingly, the vehicle front structure 10 may uniformly distribute the load in the event of a vehicle collision/impact, increase frontal stiffness of the vehicle body, reduce RTE (ResTraint Energy), and improve load bearing performance.

According to exemplary embodiments of the present disclosure, lateral displacement may be induced by the three ‘U’-shaped load paths L1, L2, and L3, and lateral stiffness of the vehicle body may be increased so that driving performance of the vehicle may be improved.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle front structure, comprising:
a front end module including:
a crossmember disposed in a first direction of a vehicle; and
a pair of side members extending vertically from first and second end portions of the crossmember;
a pair of vertical members connected on a rear surface of the front end module;
a pair of fender apron members connected to top end portions of the pair of vertical members, respectively; and
a pair of front side members connected to a middle portion of the front end module,
wherein each fender apron member extends in a second direction of the vehicle.

2. The vehicle front structure of claim 1, wherein a front end portion of each fender apron member is at least partially overlapped with and is fixed to a top end portion of a corresponding vertical member.

3. The vehicle front structure of claim 2, further including:
a pair of reinforcing plates fixed to rear surfaces of the pair of side members,
wherein the pair of vertical members are fixed to rear surfaces of the pair of reinforcing plates.

4. The vehicle front structure of claim 3, wherein a front end portion of each front side member is fixed to a rear surface of a corresponding reinforcing plate.

5. The vehicle front structure of claim 1, further including:
a pair of mounting brackets connected to bottom end portions of the pair of vertical members, respectively; and
a front sub-frame connected on the pair of mounting brackets.

6. The vehicle front structure of claim 5, wherein each mounting bracket extends vertically from a bottom end portion of a corresponding vertical member.

7. The vehicle front structure of claim 5, wherein the crossmember of the front end module includes a closed cross section and a front cross section of the front sub-frame includes a closed cross section.

8. The vehicle front structure of claim 7, wherein the mounting brackets are integrally connected to the vertical members so that the mounting brackets and the vertical members form a unitary one-piece.

9. The vehicle front structure of claim 1, further including:
a front bumper connected to the middle portion of the front end module,
wherein the front bumper is connected to the pair of side members through a pair of crash boxes.

10. The vehicle front structure of claim 9, wherein the crossmember of the front end module includes a closed cross section and the front bumper includes a closed cross section.

11. The vehicle front structure of claim 1, further including:
a pair of damper housings connected to the pair of fender apron members, respectively.

12. The vehicle front structure of claim 11, wherein a top edge portion of each damper housing is fixed to a corresponding fender apron member and a bottom edge portion of each damper housing is fixed to the corresponding front side member.

13. The vehicle front structure of claim 1, wherein the crossmember and the pair of side members are made of different materials.

14. A vehicle including the vehicle front structure of claim 1.
